(19) United States
(12) Patent Application Publication
(10) Pub. No.: US 2003/0204714 A1
(43) Pub. Date: Oct. 30, 2003

(54) Methods and apparatuses for uniform configuration for a computer system

(76) Inventors: Michael A. Rothman, Gig Harbor, WA (US); Robert P. Hale, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/132,015

(22) Filed: Apr. 24, 2002

(51) Int. Cl. G06F 1/24; G06F 15/177

(52) U.S. Cl. 713/100; 713/2

(57) ABSTRACT

Methods and apparatuses for uniform configuration for a computer system. During a runtime stage for the computer system, configuration data for configurable devices populating the computer system is retrieved from a buffer. The buffer containing the configuration data is transferred to this buffer during a pre-boot stage of the computer system. A homepage comprising a configuration menu for each of the configurable devices based on the configuration data is generated during the pre-boot stage. The homepage is presented to an operator for configuration setup for each of the configurable devices at the operator's request either during the pre-boot stage or during the runtime stage. The operator selects the desirable configuration setup. The data for this configuration setup is stored in a nonvolatile storage module, which is included within the computer system.

### FIELD

The embodiments of the invention relate generally to the field of machine firmware configuration and, more specifically, to configuring of the machine's firmware in a uniform manner regardless of whether the machine is in pre-boot stage or in operating system runtime.

### BACKGROUND

It is well established in the art that when a machine such as a computer system is turned on, configurations of the computer system and the configurable devices populating the computer system occur. The computer system is configured to perform various routines before the computer system is ready for use. The manners in which these various routines are carried out depend on the particular configuration of the computer system or the various configurable devices in the computer system. For instance, a configuration setup dictates whether the computer system will perform an exhaustive memory test or a brief memory test prior to boot up (computer system is turned on and is in ready stage). In another example, the configuration setup for the computer system dictates whether to boot the computer system up from a hard drive, a floppy, or a CD ROM installed in the computer system.

Generally, a user's ability to configure the computer system or any hardware devices (video cards, network cards, etc.) present in the computer system is restricted to the pre-boot stage. For example, during pre-boot stage, the user may press a command or a function key to go into configuration mode. This selection must be done before the computer system enters the boot up stage.

As more and more hardware for computer systems are being developed with configuration options presented to the user, and the flexibility as to when configuration can occur, hardware manufacturers have been creating two different drivers (e.g., routines) that are installed in the particular hardware that enable the user to configure the hardware when the computer system is in the pre-boot stage as well as in the boot up stage. One driver is created to enable configuration during pre-boot stage. And, another (second) driver is created to enable configuration during boot up stage. However, as is well known, a computer system is often equipped with a particular operating system (e.g., Macintosh OS, DOS, Windows, Windows NT, and UNIX) that runs the computer system during post-boot operation. To enable configuration of any device in the boot up stage, the additional second drivers must be written to communicate with the particular operating system. The existence of many different operating systems forces the manufacturers to develop several different drivers to accommodate these different operating systems. The making of the devices are thus unnecessarily expensive and complex.

### BRIEF DESCRIPTION OF THE DRAWINGS

The invention will be understood more filly from the detailed description given below and from the accompanying drawings of various embodiments of the invention, which, however, should not be taken to limit the invention to the specific embodiments, but are for explanation and understanding only. In the drawings:

FIG. 1 illustrates an exemplary embodiment of a mechanism that enables uniform configuration for both the pre-boot stage and the runtime stage of a computer system;

FIG. 2 illustrates an exemplary method of configuring a machine such as a computer system;

FIG. 3A illustrates another exemplary method of configuring a machine such as a computer system;

FIG. 3B illustrates yet another exemplary method of configuring a machine such as a computer system; and

FIG. 4 illustrates a computer system that a uniform configuration mechanism can be applied to.

### DETAILED DESCRIPTION

In the following description, numerous specific details are set forth. However, it is understood that embodiments of the invention may be practiced without these specific details. In other instances, structures and techniques have not been shown in detail in order not to obscure the understanding of this description.

The embodiments of the invention also relates to apparatus (e.g. an application routine or device having an application routine) for performing the operations herein. This apparatus may be specially constructed for the required purposes, or it may comprise a general purpose computer selectively activated or reconfigured by a computer program stored in the computer. Such a computer program may be stored in a computer readable storage medium.

For the purposes of this discussion, the term “machine-readable medium” shall be taken to include any medium that is capable of storing or encoding a sequence of instructions for execution by a machine such as a computer and that cause the machine to perform any one of the methodologies of the embodiments. The term “machine-readable medium” shall accordingly be taken to include, but not be limited to, solid-state memories, read only memories (ROMs) random access memories (RAMs), erasable programmable ROM (EPROMs), electrically erasable programmable ROM (EEPROMs) magnetic or optical cards, optical and magnetic disks, (e.g., floppy disks, compact disc ROM (CD-ROMS), and digital video disc (DVD-ROMS)) magnetic-optical disks, and carrier wave signals, or any type of media suitable for storing electronic instructions. A machine-readable medium can also be a computer-readable medium that is coupled to a computer system bus present in the computer.

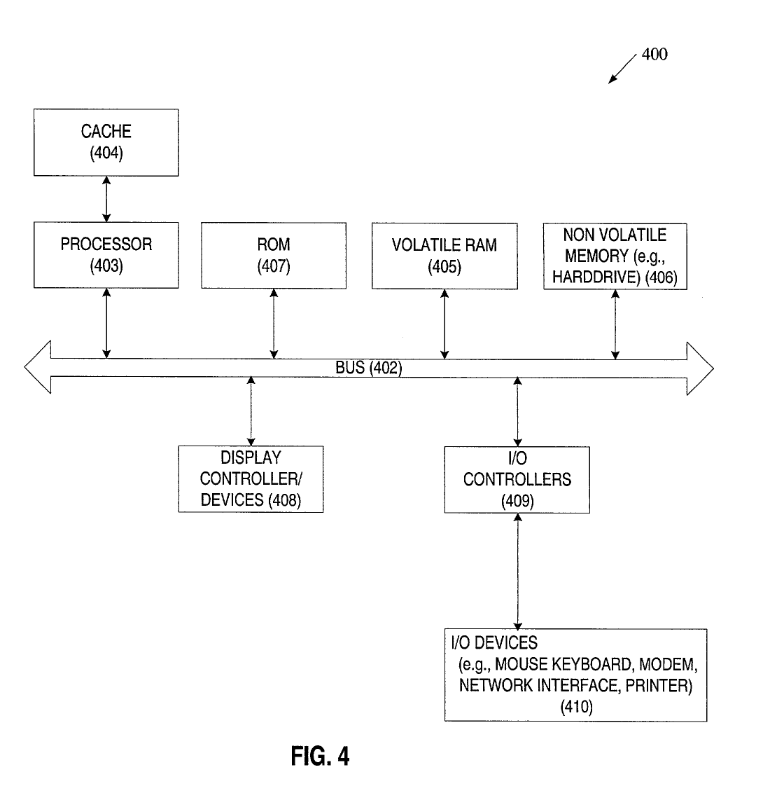

FIG. 4 illustrates one example of a typical computer system 400 which may be used. Note that while FIG. 4 illustrates various components of a computer system, it is not intended to represent any particular architecture or manner of interconnecting the components, as such details are not germane to this discussion. It will also be appreciated that the network computers and other data processing systems, which have fewer components or perhaps more components, may also be used. The computer system of FIG. 4 may, for example, be an Apple Macintosh or an IBM-compatible computer.

As shown in FIG. 4, the computer system 400, which is a form of a data processing system, includes a bus 402, which is coupled to a processor or a microprocessor 403, a ROM 407, a volatile RAM 405, and a non-volatile memory 406. The processor 403, which may be a Pentium microprocessor from Intel Corporation, is further coupled to a cache memory 404 as shown in the example of FIG. 4. The bus 402 interconnects these various components (e.g., the processor 403, the ROM 407, the volatile RAM 405, and the non-volatile 406) together. The bus 402 further interconnects these various components to a display controller and a display device 408 (e.g., a liquid crystal display (LCD), a flat panel display, or a cathode ray tube (CRT)). The bus 402 yet further interconnects these various components to peripheral devices 410 such as input/output (I/O) devices, which may be mice, keyboards, modems, network interfaces, printers, and other devices, which are well known in the art. Typically, the I/O devices are coupled to the computer system 400 through an I/O controller 409. The volatile RAM 405 is typically implemented as a dynamic RAM (DRAM), which requires power continuously in order to refresh or maintain the data in the memory. The non-volatile memory 406 is typically a magnetic hard drive, a magnetic optical drive, an optical driver, a DVD RAM, or other type of memory system, which maintains data even after power is removed from the computer system 400. Typically, the non-volatile memory 406 will also be a random access memory, although this is not required. While FIG. 4 shows that the non-volatile memory 406 is a local device coupled directly to the rest of the components in the computer system 400, it will be appreciated that the non-volatile memory 406 can be non-volatile memory that is remote from the computer system 400, such as a network storage device which is coupled to the data processing system through a network interface such as a modem or an Ethernet interface. The bus 402 may include one or more buses connected to each other through various bridge, controller, and/or adapters, as is well known in the art. In one embodiment, the I/O controller 409 includes a Universal Serial Bus (USB) adapted for controlling USB peripheral devices.

The routines or set of instructions described herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the exemplary embodiments below are not described with reference to any particular programming language. It will be appreciated that a variety of programming languages may be used to implement the embodiments as described herein.

The exemplary embodiments below describe methods and apparatuses for a novel mechanism that allows for configuration of a computer system's firmware (e.g., ROM, PROM, EPROM, EEPROM, and other memory chips capable of holding contents without electrical power) irrespective of whether the computer system is in a pre-boot or booting up stage or in runtime stage. The exemplary embodiments further provide a user with the ability to configure the traditional motherboard system setup and any configurable devices such as option cards, network cards, RAID controller, etc . . . , in a uniform manner. The term configurable devices indicates that the devices can be added to the computer system and the drivers for the devices invite or allow the user to configure the setup of the devices if the user desires to. The term uniform manner indicates that configuration for the computer system and any configurable devices populating the computer system will be the same whether the computer system is in the pre-boot stage/booting up stage or in the runtime stage. The pre-boot or the booting up stage refers to the stage when the computer system is first turned on with all devices being initiated. The pre-boot stage or the booting up stage occurs prior to the completion of all of the necessary testing of the computer system and when the computer system's operating system (e.g., Windows) is started. For example, during the pre-boot stage, the BIOS (Basic Input/Output System) for the computer system typically enables the computer system to communicate with and test various devices to allow configuration of the devices that are connected to the computer system. When all configuration and testing is completed, the operating system will take over the control of the computer system. The runtime stage refers to the stage when the computer system's operating system has control after the boot up stage and runs the computer system. The runtime stage can be also referred to as the post-boot stage.

In one exemplary embodiment, during a runtime stage for the computer system, configuration data for the configurable devices populating the computer system are retrieved from a buffer. The buffer containing the configuration data for the configurable devices is transferred to this buffer during the pre-boot stage of the computer system. A homepage for the configuration data is generated based on the buffer during the pre-boot stage. The homepage comprises a configuration menu for each of the configurable devices. The homepage is presented to an operator or a user for configuration setup for each of the configurable devices at the user's request. The user may request configuration during the pre-boot stage or during the runtime stage. The request during the pre-boot stage may be made through some command such as by hitting a function key on the keyboard. The request during the runtime stage may be made by the user executing some program represented by an icon in a control panel to initiate runtime configuration. The user may select the appropriate or desirable configuration setup. The data for this configuration setup is then stored in a nonvolatile storage module, which is included within the computer system.

In another exemplary embodiment, during the pre-boot stage, the configuration data for each of the configurable devices is exported and collected into various buffer locations. This configuration data may be the configuration setup that was previously selected by the user or the default setup for each device. The configuration data is then organized into one unified buffer. The unified buffer can be the same buffer from where the configuration data for configurable devices is retrieved during the runtime stage configuration mentioned above. The configuration data for each configurable device is allocated a predetermined space in the unified buffer. An indication for the location of the unified buffer is created. For example, a unique identifier for the unified buffer is installed to indicate the location of the unified buffer. Additionally, a point pair is also installed to indicate a starting point for the unified buffer. The starting point indicates information as to where the configuration setup begins for each of the configurable devices. For the pre-boot stage configuration, the homepage is presented to the user during the pre-boot stage. For the runtime stage configuration the homepage is read by a set of instructions residing in the computer system's operating system and is presented to the user during the runtime stage using the operating system's interface. The user performs configuration selection essentially in the same manner whether the computer system is the runtime or in the pre-boot stage.

The computer system such as that described in FIG. 4 having a memory for storing instructions can be used to perform the embodiments of this discussion. Additionally, a machine-readable medium or a computer-readable medium for storing instructions that can be coupled to the computer system can also be used. When the instructions are executed on the processor, they cause the processor to perform functions that carry out the embodiments of this discussion.

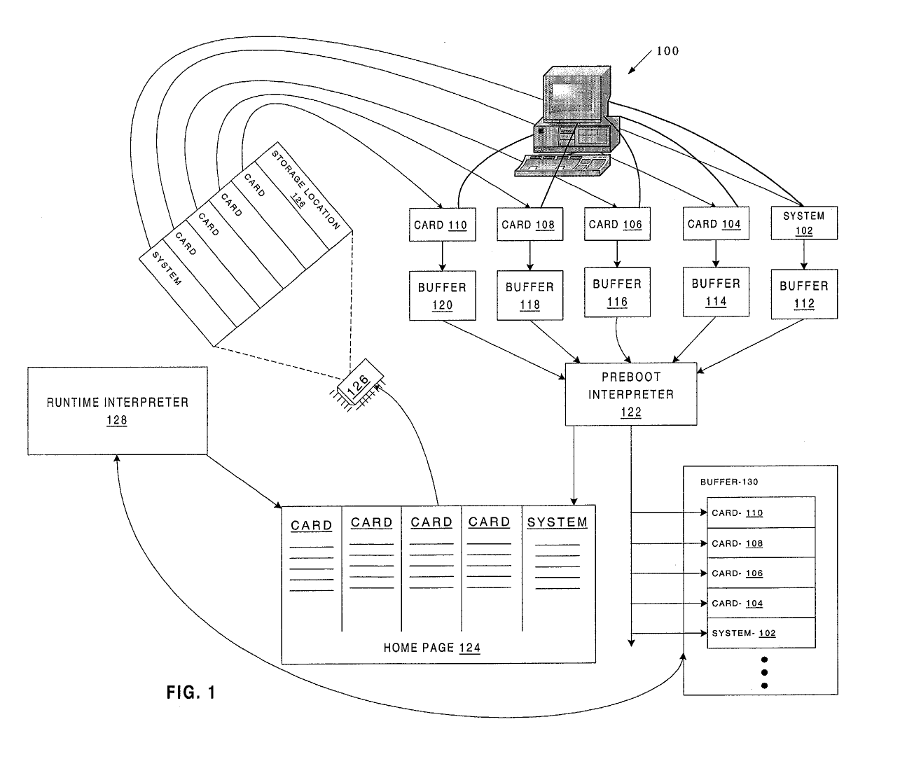

FIG. 1 illustrates an exemplary embodiment of a computer system that has a mechanism that enables it to configure the system and any other configurable devices populating the system whether the system is in the pre-boot stage or in the runtime stage. The ability to allow configuration in the pre-boot stage as well as in the runtime stage further includes providing the user with the opportunity to configure the system in a uniform manner: the configuration can occur either on the pre-boot or the booting up stage (e.g., during the POST—power-on self test of the computer system); alternatively, the configuration can occur when the operating system is already running. The term “uniform manner” signifies that the utility has the traditional interface and the possibilities peculiar to a conventional setup program (e.g., conventional BIOS setup program).

The computer system 100 comprises a system motherboard 102, a card 104, a card 106, a card 108, and a card 110. Each of the cards 104, 106, 108, and 110 can be, for example, a network card interface, a Redundant Array of Independent Disks (RAID) controller card, a video card, or any other device that is configurable and addable to the computer system 100. Configurable devices refer to those devices that have setup information that the user is able to change, set, or setup. The configurable devices thus have drivers (e.g., software, instructions, or codes) that are created to invite or to enable the user to select a desirable configuration setup. The computer system 100 represents a system with four add-in cards, which have setup presentations in addition to the main system, which also has setup information.

Each of the devices, the cards 104, 106, 108, 110 or the system motherboard 102, include a plurality of questions and answer information relating to the setup for the devices. The information relating to the setup for the device is exported to a central storage place in the computer system, a unified buffer 130. The information is exported as a binary image, which encodes a set of interpretable operation codes, strings, and fonts. The operation codes indicate the name and type of the device for which a particular set of configuration information is being exported. For example, the operation code may say, “this is the main system configuration setup.” The strings indicate the abstract information regarding the configuration setup for any particular device. For example, the strings may comprise of the questions and answers relating to the configuration setup. A configuration menu can be generated using the strings to show the questions to the user and accept the answers from the user's selection during a configuration process. The fonts indicate how the configuration setup menu can be presented to the user, for instance, what kind of font, paragraph, size, appearance, and the like will be used to present the strings to the user.

In one embodiment, an interpreter 122, which is a set of instructions, collects all of the exported configuration data, organizes it, and copies it into a unified buffer 130 that is persistent into the runtime stage of the computer system. In one example, the interpreter 122 is also a set of instructions that initializes all of the devices in the computer system 100. The interpreter 122 may resides in a FLASH memory device in the computer system 100. A FLASH memory is well known to those of ordinary skill in the art. The interpreter 122 operates within the pre-boot stage to setup the unified buffer 130. The interpreter 122 can be referred to as a pre-boot interpreter. In another example, the unified buffer 130 created by the interpreter 122 is stored in a RAM when the computer system is on. This RAM storage enables the unified buffer 130 to be persistent into the runtime stage of the computer system. The buffer 130 is created in such a way that any known operating system that runs on the computer system 100 can locate and access the buffer 130 during the runtime phase.

In another exemplary embodiment, the information relating to the setup for each of the device is first exported to a random buffer storage prior to being collected at the unified buffer 130. For example, the configuration information for the system 102 is first exported to a buffer 112; the configuration information for card 104 is first exported to a buffer 114; the configuration information for card 106 is first exported to a buffer 116; the configuration information for card 108 is first exported to a buffer 118; and, the configuration information for card 110 is first exported to a buffer 120. In this embodiment, the interpreter 122 collects and organizes all of the configuration information from the various buffers into the unified buffer 130.

In another example, the interpreter 122 dynamically creates the unified buffer 130 as new information is being exported into the buffer. Additional setup information for additional devices of new setup information can be continuously added to the unified buffer 130. In this example, the user will have the opportunity to view the configuration setup that was chosen during the pre-boot stage as well as the choices for changes in the configuration setup during the runtime stage.

In one example, the interpreter 122 creates the unified buffer 130 to be a runtime memory buffer, which is designated to be preserved during the runtime phase of computer system 100. The content of the buffer 130 is the information that can be used to create the homepage 124. Furthermore, the interpreter 122 allocates spaces in the unified buffer 130 for the configuration data for each of the devices such as the cards 104, 106, 108, 110 or the system motherboard 102.

The interpreter 122 generates a homepage 124 based on the information stored in the unified buffer 130. In one example, the homepage 124 is located within the unified buffer 130. In another example, the interpreter 122 places the homepage 124 in another buffer location that is also persistent during the runtime stage. The homepage 124 contains a configuration menu for each of the devices that has been exported into the unified buffer 130. Thus, when the computer system 100 only has four cards as shown in FIG. 1, the homepage 124 contains only five configuration menus, one for each of the four cards and one for the system 102. Additionally, the interpreter 122 installs a globally unique identifier (GUID) to the buffer 130. The GUID is a unique value of about 128 bits that is assigned to identify the location of the unified buffer 130 which comprises configuration data sets for the configurable devices for the computer system 100. Additionally, another GUID value can be attached to the homepage 124 in the example where the interpreter 122 places the homepage 124 in a different buffer. The GUID value can be standardized and published so that manufacturers of the devices and developers of the drivers of the devices (drivers of the devices are instructions for the operation of the devices) can adapt the devices to work under this invented mechanism. The GUID values thus enable proper retrieval of the configuration data by properly locating the unified buffer 130. Furthermore, the interpreter 122 installs a pointer pair for each configuration data set to indicate the beginning of the place in the unified buffer 130 where the configuration data begin.

In one exemplary embodiment, the pre-boot interpreter or the interpreter 122 presents the homepage 124 to the user when the user indicates the desire to configure the computer system 100 and other devices populating the computer system 100. In one example, the user indicates the desire to configure by entering some commands during the pre-boot or the booting up stage. The user may hit a function key on a conventional keyboard (e.g., F1, F2, or F3) that will command the interpreter 122 to present the homepage 124 to the user for configuration setup.

The homepage 124 presents to the user an interface with configuration menu for each of the configurable device and the system motherboard that are populating the computer system. Each of the configuration menus contain the abstract information pertaining to the configuration setup created specifically for each of the devices. The abstract information may include questions that the user needs to answer and answer selections from which the user may pick in response to the questions. The abstract information can be strings of information that a particular device manufacturer or developer installs for that device. The abstract information may simply be the conventional configuration setup information that is currently being used in the field. Furthermore, the abstract information is presented to the user in any manner set by the manufacturer or developer of each of the devices as mentioned above. In the example where the answer selections are presented for the user to choose for each question pertaining to configuration setup, the user will choose one of the selections or choices from the configuration menu. The user may make adjustments to the motherboard system configuration, or any other configurable device through the homepage 124 that is presented by the interpreter 122. When the changes are ready to be committed, the interpreter 122 will store the configuration data to a storage location 126. The storage location 126 is preferably a non-volatile storage module or any storage module that is persistent, e.g., a non-volatile RAM.

When the configuration during the pre-boot or the booting up stage is completed, the configuration information that is stored in the storage location 126 can be retrieved by the devices (e.g., the cards 104, 106, 108, 110, and the motherboard 102). Each corresponding driver for each of the devices will check the storage location 126 to determine what the user has selected (if anything) and setup the device accordingly. In one example, each of the drivers is responsible for enacting the selections or choices that the user made using conventional methods. The devices can thus be setup according to the user's selections using conventional methods before the computer system 100 goes into the runtime stage where the operating system controls the computer system 100.

In another exemplary embodiment, the configuration setting occurs during the runtime stage of the computer system 100. In this embodiment, when the operating system is running, another interpreter, interpreter 128 locates the unified buffer 130 and carries out similar task as the interpreter 122 to present configuration setup menu to the user. The interpreter 128 can be referred to as a runtime interpreter. In essence, the interpreter 128 is also a set of instructions, codes, or software that can carry out tasks similar to the interpreter 122. The interpreter 128, however, typically resides in the operating system of the computer system 100 and performs the tasks performed by the pre-boot interpreter 122, except that the interpreter 128 does so during the runtime stage. Additionally, the interpreter 128 does not need to generate the homepage 124. Instead, the interpreter 128 reads or interprets the homepage 124.

Similar to the interpreter 122, the interpreter 128 of this embodiment presents the homepage 124 to the user when the user indicates the desire to configure the computer system 100 and other devices populating the computer system 100, during the runtime stage. In one example, the user indicates the desire to configure by entering some commands during the runtime stage. The user may hit a function key on a conventional keyboard (e.g., F1, F2, or F3) that will command the interpreter 128 to present the homepage 124 to the user for configuration setup. Alternatively, the operating system can be setup so that the interpreter 128 can present a configuration option to the user through a conventional control panel such as the control panel currently used in the Windows operating system. The user may perform an overt act that executes the interpreter 128. For example, an icon can be installed in the control panel to provide a manner where the user can execute the interpreter 128. As the user clicks on the icon with a conventional mouse or otherwise chooses the icon, the interpreter 128 is launched and the runtime configuration may begin.

The homepage that is being presented to the user for configuration setup during runtime can be the same homepage 124 created by the interpreter 122 discussed above. Alternatively, this homepage may be different so long as it presents the appropriate setup information to the user. It is preferred that this homepage is the same homepage as the homepage 124 to give the user the uniform configuration experience whether the user performs the configuration during the runtime or during the pre-boot or booting up stage.

In one example, the interpreter 128 is programmed to look for the GUID that is installed in the unified buffer 130 as mentioned above and uses the pointer pair associating with the GUID to retrieve the configuration data for the devices. In this example, the GUID is a communication mechanism that allows the pre-boot interpreter 122 to communicate to the runtime interpreter 128. The buffer 130 is formatted with the GUID and pointer pair, which identify the location of the unified buffer 130 to the interpreter 128 and the beginning of the data in the buffer. Based on the information that the interpreter 128 is able to locate and interpret from the unified buffer 130, the interpreter 128 then presents to the user the appropriate setup related questions using the homepage 124. In one example, the interpreter finds all occurrences of the configuration setup information that have been exported to the unified buffer 130. The interpreter 128 interprets the codings correlating to the configuration setup information for each of the devices and dynamically creates an encoding to represent the homepage 124 which lists to the user all of the items in the computer system which have exported configuration setup information.

The unified buffer 130 will also lead the interpreter 128 to the homepage 124 generated based on the content of the unified buffer 130. In the example where the homepage 124 is placed in the same place as the unified buffer 130 (or within the unified buffer 130) the runtime interpreter 128 looks for the GUID to find the unified buffer 130 from which the runtime interpreter 128 can locate the homepage 124 to read. In the example where the homepage 124 is not in the same location as the unified buffer 130, the runtime interpreter 128 must be able to know the GUID that identifies the location of the homepage 124 or that the pre-boot interpreter 122 must provide an indication of this location. As mentioned above, another GUID value may have been installed in the homepage 124. The runtime interpreter 128 would know of this GUID value and look for it to go to the homepage 124.

In one example the answer selections are presented for the user to choose for each question pertaining to configuration setup just as in the pre-boot stage configuration. The user will choose one of the selections or choices from the configuration menu. The user may make adjustments to the motherboard system configuration, or any other configurable device through the homepage 124 that is presented by the runtime interpreter 128. When the changes are ready to be committed, the runtime interpreter 128 will store the configuration data to a storage location 126. The storage location 126 is preferably a non-volatile storage module or any storage module that is persistent, e.g., a non-volatile RAM.

The configuration data remains in the storage location 126 until when computer system is rebooted or reset as is normally needed to enact a configuration change in the system setup. During reboot, the devices (e.g., the cards 104, 106, 108, 110, and the motherboard 102) retrieve the configuration data from the storage location 126. Each corresponding driver for each of the devices will check the storage location 126 to determine what the user has selected (if anything) and setup the device accordingly. In one example, each of the drivers is responsible for enacting the selections or choices that the user made using conventional methods. The devices then use the configuration data to setup the devices according to the user's selections using conventional methods before the computer system 100 goes into the runtime stage where the operating system controls the computer system 100.

In one example, the storage location 126 has appropriate allocation for each of the configuration data set for each of the devices as shown in FIG. 1. The storage location 126 may have the same setup as the unified buffer 130. In one example, the pre-boot interpreter 122 and the runtime interpreter 128 know where to store the data, such that the device can locate them. In this example, each device is allocated a predetermined space in the storage location 126. Each device is equipped with a driver that will have expectation of where its corresponding configuration data will be in the storage location 126 and the driver will go to that location to read the configuration data.

Extending the ability to do complete firmware and other option devices that are configurable devices both in the pre-boot/booting up stage as well as during runtime stage is highly advantageous since it reduces the need for creating setup applications that are usable solely in a particular operating system such as Microsoft Windows. The mechanisms of the exemplary embodiments allow for a generic mechanism to provide setup information to most operating system. Furthermore, the embodiments lower the cost of making hardware and devices by off-loading manufacturers and developers' task by not requiring the manufacturers and developers to create additional and separate set of instructions to enable configuration during runtime stage in any particular operating system. These manufacturers and developers thus need to write only a single setup infrastructure, which is provided in the pre-boot/booting up stage. This setup infrastructure is used in the runtime configuration using the mechanism described in the embodiments.

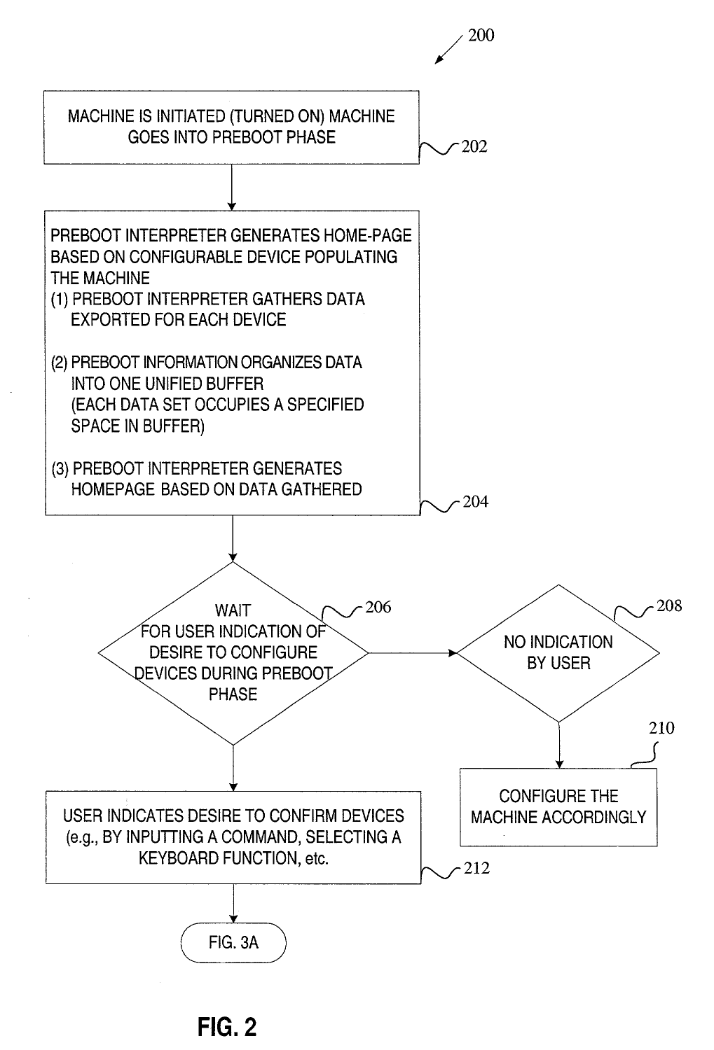

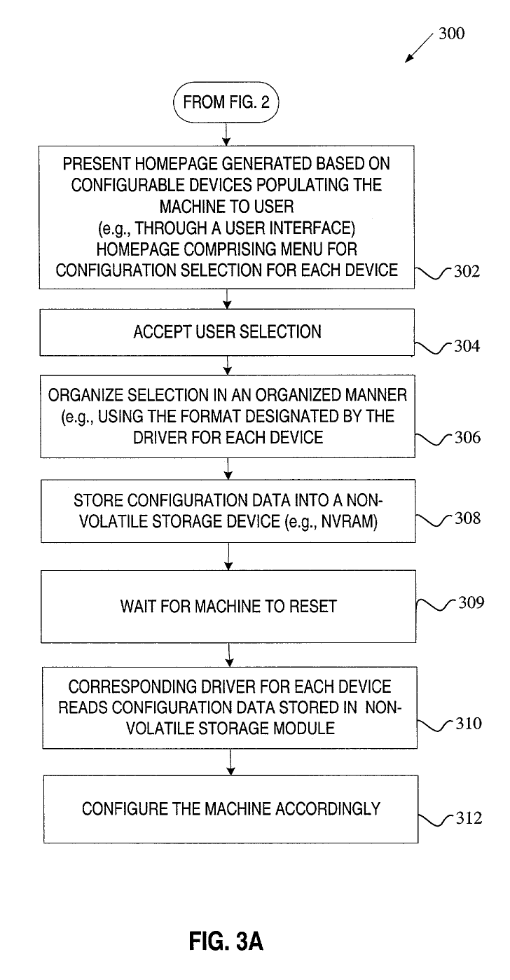

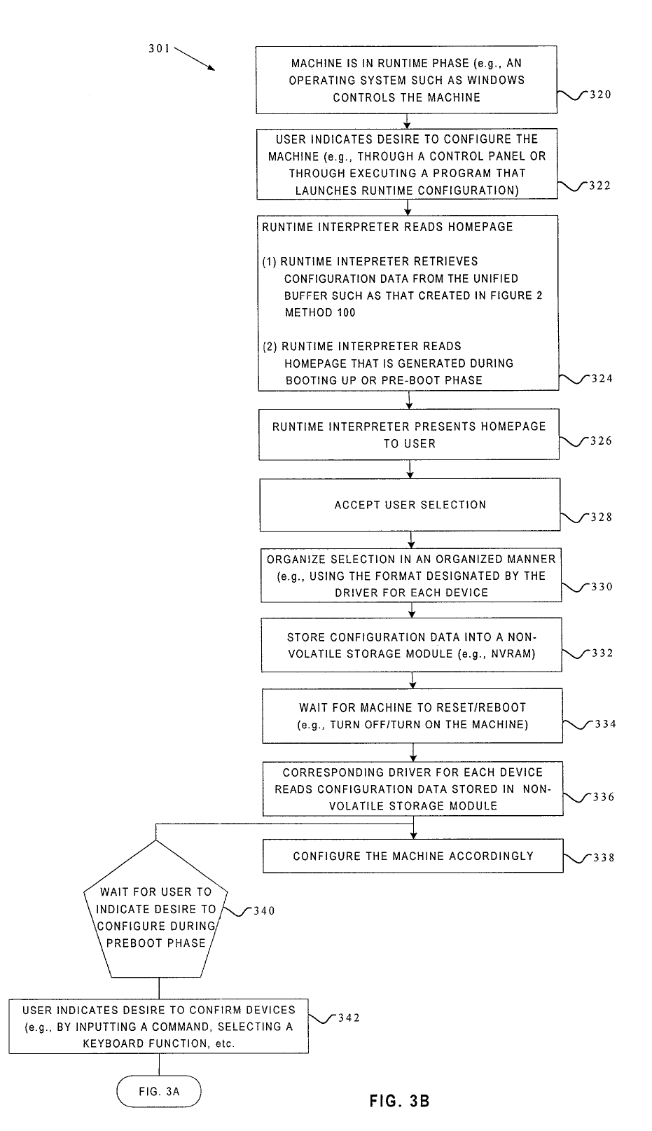

FIGS. 2, 3A, and 3B illustrate exemplary methods of configuration of a machine such as the computer system 100 described above.

As illustrated in FIG. 2, in method 200, at operation 202, the machine is initiated or turned on. After all of the necessary conventional self-tests, the machine enters pre-boot or booting up phase. At operation 204, a pre-boot interpreter generates a homepage based on the configurable devices populating the machine. The pre-boot interpreter first gathers all of the configuration data that have been exported from each of the configurable devices including the motherboard system. The pre-boot interpreter then collect and organizes the configuration data into one unified buffer. The pre-boot interpreter also allocates a particular space in the unified buffer to each of the configuration data set corresponding to each of the devices. The pre-boot interpreter then generates the homepage containing configuration menus for all of the appropriate devices based on the configuration data.

At operation 206, during the pre-boot/booting up phase the machines waits for the user to indicates the desire to configure the machine and the devices populating the machine. If there is no indication for desire to configure the machine during the pre-boot/booting up phase, as shown in the operation 208, the pre-boot interpreter uses the configuration data that have been exported and configure the machine using conventional methods (operation 210). If there is an indication for the user's desire to configure the machine during the pre-boot/booting up phase, the configuration is performed according to the method 300 illustrated in FIG. 3A. The user may indicate the desire to configure the machine during the pre-boot phase using an input/output device such as a conventional keyboard and entering a command.

At operation 302, pre-boot interpreter presents the homepage generated based on the configurable devices populating the machine as mentioned above to the user. The homepage acts as a user interface to present the user with options or selections pertaining to configuration setup for the devices. The homepage comprises configuration menu for all of the devices that have exported configuration data into the unified buffer where the user can set the desirable setup for each device.

At operation 304, the pre-boot interpreter accepts the user selections. At operation 306, the pre-boot interpreter organizes the selection into a manner that the drivers for the devices can recognize. At operation 308, the pre-boot interpreter stores the configuration data into a storage location that is nonvolatile, for example, a NVRAM. At operation 309, the machine waits for a reset.

At operation 310, after the machine is reset, the corresponding driver for each device reads the configuration data stored in the storage location. In one example, the devices have corresponding drivers that know how to get to the storage location and retrieve the configuration data. And, at operation 312, the machine and the devices populating the machine are configured according to the configuration data retrieved from the storage location.

The method 301 as shown in FIG. 3B illustrates an exemplary method of configuring the machine while in the runtime phase. At operation 320, the machine is in the runtime phase, for example, when the operating system of the machine such as Windows is controlling the machine. At operation 322, the user indicates a desire to configure the machine, e.g., by selecting an option presented to the user in a control panel.

At operation 324, a runtime interpreter generates a homepage based on the configurable devices populating the machine. The runtime interpreter first retrieves all of the configuration data from a unified buffer such as the unified buffer that has been created according to the method 100 of FIG. 2. The runtime interpreter then generates the homepage containing configuration menus for all of the appropriate devices based on the configuration data gathered from the unified buffer.

At operation 326, the runtime interpreter presents the homepage to the user using for example, an interface allowed through the operating system of the machine. At operation 328, the runtime interpreter accepts the user selections. At operation 330, the runtime interpreter organizes the selection into a manner that the drivers for the devices can recognize. At operation 332, the runtime interpreter stores the configuration data into a storage location that is nonvolatile, for example, a NVRAM.

At operation 334, the machine continues with normal operations and waits for the reset or reboot of the machine to enact the configuration changes, if any. Typically, turning on or off the machine resets the machine. Alternatively, a reset button may also be present and as the user presses the reset button, the machine enters reset/reboot mode. At operation 336, as the machine is initiated after the reset, the corresponding driver for each device reads the configuration data stored in the storage location. In one example, the devices have corresponding drivers that know how to get to the storage location and retrieve the configuration data.

During the booting up (or pre-boot) phase, the machine may wait for the user to indicate desire to configure the machine during the booting up phase as shown in operation 340. If the user indicates desire to configure the machine during this booting up phase, as shown in operation 342, the method 300 described in FIG. 3A is repeated. And, if there is no user indication of configuring during this booting up phase, the machine and the devices populating the machine are configured according to the configuration data that are retrieved from the storage location as shown in operation 338.

While the invention has been described in terms of several embodiments, those skilled in the art will recognize that the invention is not limited to the embodiments described but can be practiced with modification and alteration within the spirit and scope of the appended claims. The description is thus to be regarded as illustrative instead of limiting.

We claim:

1. A system comprising:
a processor; and
a memory to store a first set instructions which when executed cause the processor to:
retrieve configuration data for configurable devices populating said system from a buffer during a runtime stage of said system, said configuration data is placed in said buffer during a pre-boot stage of said system;
generate a homepage for said configuration data during said pre-boot stage, said homepage including a configuration menu for each of said configurable devices;
present said homepage to an operator for configuration setup for each of said configurable devices during said runtime stage; and
store said configuration setup in a nonvolatile storage module included within said system.

2. The system as in claim 1 wherein said memory further comprising a second set of instructions which when executed cause the processor to:
collect said configuration data exported from said configurable devices populating said system during said pre-boot stage;
organize said configuration data into said buffer during said pre-boot stage; and
generate said homepage comprising said configuration menu for each of said configurable devices during said pre-boot stage.

3. The system as in claim 2 wherein said configuration data exported from each of said configurable devices is exported into a random buffer storage location within said system and wherein said second set of instructions when executed causes the processor to:
retrieve said configuration data from said random buffer storage; and
organize said configuration data into said buffer wherein said configuration data for each of said configurable devices is placed into a predetermined location within said buffer.

4. The system as in claim 1 wherein said first set of instructions when executed causes the processor to:
present said homepage to said operator for said configuration setup during said pre-boot stage.

5. The system as in claim 1 wherein said buffer is persistent during said runtime stage.

6. A method comprising:
during a runtime stage of said system, retrieving configuration data for configurable devices populating said system from a buffer, said configuration data is placed in said buffer during a pre-boot stage of said system;
during said runtime stage, generating a homepage for said configuration data, said homepage comprising a configuration menu for each of said configurable devices;
during said runtime stage, presenting said homepage to an operator for configuration setup for each of said configurable devices; and
during said runtime stage, storing said configuration setup in a nonvolatile storage module included within said system.

7. The method as in claim 6 wherein said presenting said homepage to an operator for configuration setup further comprising:
presenting configuration setup questions to said operator; and
accepting configuration setup answers directing to said configuration setup questions.

8. The method as in claim 7 further comprising repeating said presenting and said accepting until said an operator completes said configuration setup.

9. The method as in claim 6 further comprising:
during a pre-boot stage, exporting said configuration data for each of said configurable devices;
during said pre-boot stage, collecting said configuration data for said each of said configurable devices into various buffer locations; and
during said pre-boot stage, organizing said configuration data into said buffer.

10. The method as in claim 9 wherein said organizing said configuration data into said buffer further comprising:
allocating a predetermined space in said buffer for data from each of said configurable devices; and
indicating a location for each of configurable devices in said buffer.

11. The method as in claim 9 further comprising:
during said pre-boot stage, generating said homepage comprising said configuration menu for each of said configurable devices.

12. The method as in claim 11 further comprising:
during said pre-boot stage, presenting said homepage to said operator for configuration setup for each of said configurable devices.

13. The method as in claim 12 wherein said presenting said second homepage to an operator for configuration setup further comprising:
presenting configuration setup questions to said operator; and
accepting configuration setup answers directing to said configuration setup questions.

14. The method as in claim 13 further comprising repeating said presenting and said accepting until said an operator completes said configuration setup.

15. The method as in claim 9 further comprising:
during said pre-boot stage, installing a unique identifier for each of said configuration data for each of said configurable devices;
during said pre-boot stage, installing a point pair for each of said configuration data to indicate a starting point for each of said configuration data, said starting point to indicates information for said configuration setup begins for each of said configurable devices.

16. A machine readable medium comprising instructions stored therein, which when executed on a processor, said instructions cause the processor to:
during a runtime stage of said system, retrieve configuration data for configurable devices populating said system from a buffer, said configuration data is placed in said buffer during a pre-boot stage of said system;
during said runtime stage, generate a homepage for said configuration data, said first homepage comprising a configuration menu for each of said configurable devices;
during said runtime stage, present said homepage to an operator for configuration setup for each of said configurable devices; and
during said runtime stage, store said configuration setup in a nonvolatile storage module included within said system.

17. The machine readable medium comprising instructions as in claim 16 wherein said instructions when executed further cause the processor to:
during said runtime stage, present configuration setup questions to said operator; and
during said runtime stage, accept configuration setup answers directing to said configuration setup questions.

18. The machine readable medium comprising instructions as in claim 17 wherein said instructions when executed further cause the processor to:
during runtime stage, repeatedly present said configuration setup questions to said operator and accept said configuration setup answers pertaining to said configuration setup until said operator completes said configuration setup.

19. The machine readable medium comprising instructions as in claim 16 wherein said instructions when executed further cause the processor to:
during a pre-boot stage, export said configuration data for each of said configurable devices;
during said pre-boot stage, collect said configuration data for said each of said configurable devices into various buffer locations; and
during said pre-boot stage, organize said configuration data into said buffer.

20. The machine readable medium comprising instructions as in claim 19 wherein said instructions when executed further cause the processor to:
during said pre-boot stage, allocate a predetermined space in said buffer for data from each of said configurable devices; and
during said pre-boot stage, indicate a location for each of configurable devices in said buffer.

21. The machine readable medium comprising instructions as in claim 19 wherein said instructions when executed further cause the processor to:
during said pre-boot stage, generate said homepage which includes said configuration menu for each of said configurable devices.

22. The machine readable medium comprising instructions as in claim 21 wherein said instructions when executed further cause the processor to:
during said pre-boot stage, present said homepage to said operator for configuration setup for each of said configurable devices.

23. The machine readable medium comprising instructions as in claim 22 wherein said instructions when executed further cause the processor to:
during said pre-boot stage, present configuration setup questions to said operator; and
during said pre-boot stage, accept configuration setup answers directing to said configuration setup questions.

24. The machine readable medium comprising instructions as in claim 23 wherein said instructions when executed further cause the processor to:
during runtime stage repeatedly present said configuration setup questions to said operator and accept said configuration setup answers directly to said configuration setup until said operator completes said configuration setup.

25. The machine readable medium comprising instructions as in claim 19 wherein said instructions when executed further cause the processor to:
during said pre-boot stage, install a unique identifier for each of said configuration data for each of said configurable devices;
during said pre-boot stage, install a point pair for each of said configuration data to indicate a starting point for each of said configuration data, said starting point to indicates information for said configuration setup begins for each of said configurable devices.
